(19) United States
(12) Patent Application Publication
(10) Pub. No.: US 2009/0079137 A1
(43) Pub. Date: Mar. 26, 2009

(54) SEALING RINGS

(75) Inventor: Edward Henry Cross, Bath (GB)

Correspondence Address: VOLENTINE & WHITT PLLC, ONE FREEDOM SQUARE, 11951 FREEDOM DRIVE SUITE 1260, RESTON, VA, 20190, US

(73) Assignee: CROSS MANUFACTURING CO., (1938) LTD., Bath (GB)

(21) Appl. No.: 12/236,741

(22) Filed: Sep. 24, 2008

Related U.S. Application Data
(60) Provisional application No. 60/975,255, filed on Sep. 26, 2007.

(51) Int. Cl. F16J 15/16; B21D 53/84

(52) U.S. Cl. 277/550; 29/888.3

(57) ABSTRACT

This invention relates to sealing rings for use in gas turbines and methods of making them. In one embodiment the method consists in forming a sealing ring for a gas turbine including:
(a) forming a ring to the in use dimensions less a coating thickness of the ring; and
(b) depositing a coating having a thickness between about 0.125 mm and 0.077 mm.
   wherein the ring requires no further machining after step (b). Additionally or alternatively a shot peened sealing surface may be used.

This invention relates to sealing rings for use in gas turbines.

In aerospace gas turbines in particular, fuel is fed radially through the outer “shell” of the engine into the combustion can. Typically there may be twenty holes in the shell arranged evenly around the engine. The fluid feed conveyors positioned in these holes may be in a high and varying temperature environment and need to be flexibly mounted in order to accommodate the movements due to thermal expansion of the components. Piston ring type seals are therefore used to maintain a good seal and yet allow for some relative movement of the cooperating components at high temperatures. There may be as many as forty of these rings on a single gas turbine and so cost and service life are both very important. The relative movements of these components produce wear which can be a substantial problem.

The current practice is to use an out-springing, split ring, which is made undersized relative to the in use dimensions and to deposit a hard and relatively thick coating layer on the sealing surfaces of the rings at least, so as to provide long wear life. Typically, such coatings are 0.3810 mm (0.0150 inches).

However, the dimension tolerances involved are very tight and it is difficult to deposit a film of that thickness and still keep within the ring tolerances required. Post deposition machining therefore has to take place and this adds significantly to the cost of the sealing rings. Despite this problem having existed for some decades, no satisfactory solution has been found.

From one aspect the present invention consists in a sealing split ring for use in a gas turbine dimensioned to in use dimensions wherein its sealing surfaces are shot peon hardened and/or coated with a wear resistant coating of thickness in the range about 0.125 mm to about 0.077 mm.

It is particularly preferred that the coating thickness is in the range 0.1270 to 0.076 mm (0.0050 to 0.0030 inches)

The Applicants have determined that, contrary to the general prejudice in the industry, by making the ring to its in use dimensions less the coating thickness and putting on a relatively thin coating, one achieves superior sealing and satisfactory wear characteristics without needing post-deposition machining to obtain the required ring dimension tolerances.

In this process the mid-tolerance coating thickness will normally be in the region of 0.1000 mm (0.0039 inches) and the coating may be of tungsten carbide.

Alternatively, the Applicants have determined that it is equally sufficient simply to shot peen the sealing surfaces of a ring which has already been made to its in use dimensions. This process hardens the surfaces without changing the ring dimensions sufficiently so that they fall outside the required tolerances and again good wear and sealing characteristics are obtained without the need for a post-hardening machining operations. It is possible to combine both these alternative techniques in order to obtain additional enhanced wear properties.

The free ends of the ring may have overlapping formations which may be scarf cut in order to further improve the sealing properties in the region of the ring gap.

The ring may in particular form a gas turbine burner seal.

From a further aspect the invention consists in a method of forming a sealing ring for a gas turbine including:
(a) forming a ring to the in use dimensions less a coating thickness of the ring; and
(b) depositing a coating having a thickness between about 0.125 mm and 0.077 mm.
   wherein the ring requires no further machining after step (b).

From a still further aspect the invention consists in a method of forming a sealing ring for a gas turbine including:
(a) forming a ring having sealing surfaces, to the in use dimensions of the ring; and
(b) shot peening the sealing surfaces wherein the ring requires no further machining after step (b).

Although the invention has been defined above it must be understood that it includes any inventive combination of the features set out above or in the following description.

The invention may be performed in various ways and specific embodiments will now be described by way of example, with reference to the accompanying drawings in which:

FIG. 1 is a schematic cross-sectional view showing a sealing ring which in use separates two fluid spaces such that different fluid pressures may exist in the said spaces with minimum fluid flow occurring between them.

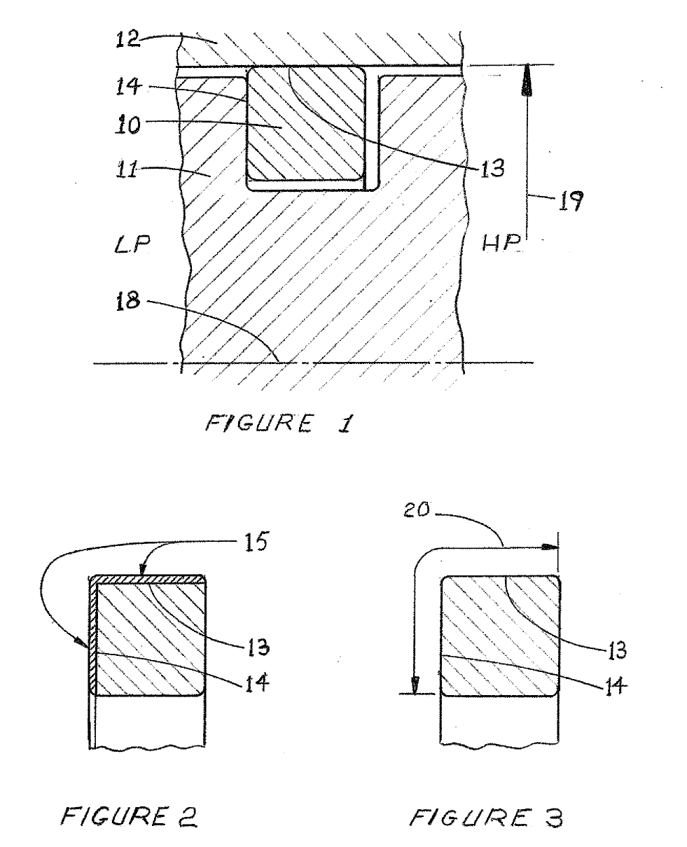

FIG. 2 is a cross section through one part of a sealing ring embodiment of the invention;

FIG. 3 is a corresponding view of an alternative embodiment of the invention;

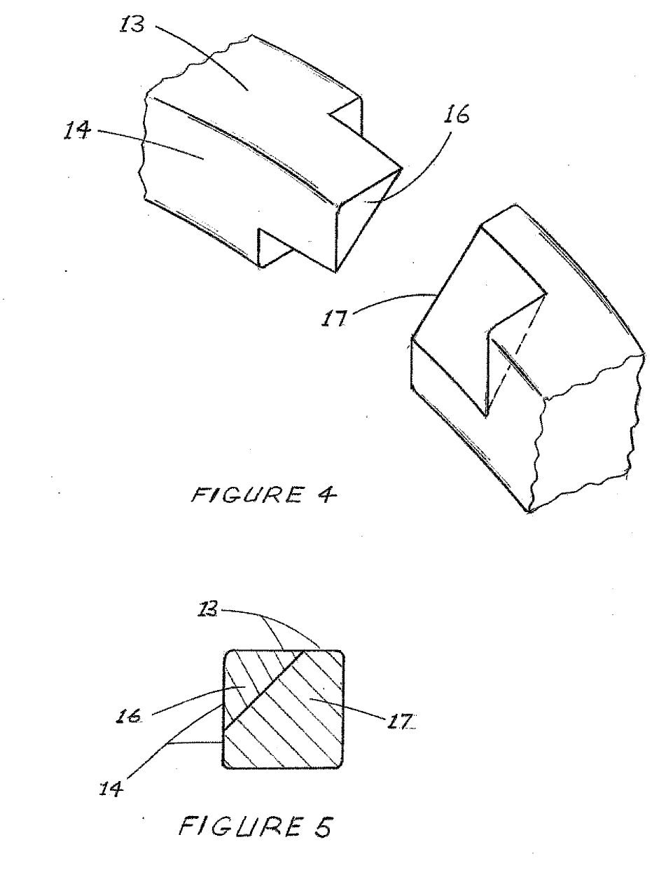

FIG. 4 is a pictorial view of the ring sections in the region of the ring gap and illustrates one design of a scarf cut abutment used to reduce fluid leakage; and

FIG. 5 shows a cross section of the scarf abutment when the two ends of the gapped ring are engaged in the in use position.

In FIG. 1 a sealing ring 10 seals between a first part 11 and a second part 12 in order to define high pressure and low pressure regions, annotated HP and LP respectively. It will be seen that the ring seals on its outer diameter surface 13 in contact with the hole diameter 19 and on a side surface 14 which is in contact with the low pressure side of the groove in part 11.

In the arrangement shown in FIG. 2 the surfaces 13 and 14 are coated with a tungsten carbide coating 15 of a thickness in the region of 0.1000 mm (0.0039 inches). For drawing clarity this thickness has been shown enlarged in FIG. 2. The reason for using this relatively thin wearing coating is to enable the in use dimensions of the ring to be held within the tight dimensional tolerances required in gas turbine engines as previously described.

In an alternative embodiment, shown in FIG. 3, the two wearing surfaces 13 and 14 at least are subjected to a shot peening operation, the at least region being designated by 20 in the drawing. The dimensions of the ring are made initially to the in use dimensions and no further machining is required following the shot peening treatment. The use of shot peening is counter intuitive, because one would expect such a treatment to provide a slightly roughened surface, which would be inappropriate for sealing purposes.

As is shown in FIGS. 4 and 5, the respective free ends 16, 17 of the split or gapped ring can be in use overlapping and scarf cut to maintain a fluid seal in the gap region of the ring 10.

1. A sealing split ring, for use in a gas turbine, dimensioned to in use dimensions and having sealing surfaces wherein its sealing surfaces are shot peen hardened and/or coated with a wear resistant coating of thickness in the range about 0.125 mm to about 0.077 mm.

2. A ring as claimed in claim 1 wherein the coating is about 0.100 mm thick.

3. A ring as claimed in claim 1 wherein the coating is tungsten carbide.

4. A ring as claimed in claim 1 wherein the free ends of the ring have overlapping formations.

5. A ring as claimed in claim 4 wherein the formations are scarf cut.

6. A ring as claimed in claim 1 wherein the sealing surfaces are shot peened.

7. A gas turbine burner seal constituted by a ring as claimed in claim 1.

8. A sealing split ring, for use in a gas turbine, dimensioned to in use dimensions and having sealing surfaces wherein the sealing surfaces are shot peened.

9. A method of forming a sealing ring for a gas turbine including:
(a) forming a ring having sealing surfaces, to the in use dimensions less a coating thickness of the ring; and
(b) treating the sealing surfaces of the ring depositing a coating having a thickness between about 0.125 mm and 0.077 mm,
wherein the ring requires no further machining after step (b).

10. A method as claimed in claim 7 wherein the thickness of the coating is about 0.100 mm.

11. A method as claimed in claim 8 wherein the coating is tungsten carbide.

12. A method as claimed wherein step (b) further includes shot peening.

13. A method of forming a sealing ring for a gas turbine including:
(a) forming a ring having sealing surfaces, to the in use dimensions of the ring; and
(b) shot peening the sealing surfaces wherein the ring requires no further machining after step (b).

14. A ring as claimed in claim 2 wherein the coating is tungsten carbide.

15. A gas turbine burner seal constituted by a ring as claimed in claim 6.
